(19) United States
(12) Patent Application Publication
(10) Pub. No.: US 2022/0259088 A1
(43) Pub. Date: Aug. 18, 2022

(54) HIGH SOLIDS ANAEROBIC DIGESTION WITH POST-DIGESTION HYDROLYSIS

(71) Applicant: ANAERGIA INC., Burlington (CA)

(72) Inventors: Andrew BENEDEK, Rancho Santa Fe, CA (US); Juan Carlos JOSSE, Aliso Viejo, CA (US)

(21) Appl. No.: 17/626,898

(22) PCT Filed: Jul. 23, 2020
(86) PCT No.: PCT/CA2020/051017

§ 371 Date: Jan. 13, 2022

Related U.S. Application Data
(60) Provisional application No. 62/878,540, filed on Jul. 25, 2019.

(51) Int. Cl. C02F 11/04; C02F 11/147; C02F 11/18

(52) U.S. Cl. CPC C02F 11/04; C02F 2303/06; C02F 11/18; C02F 11/147

(57) ABSTRACT

In a system and process, sludge from a wastewater treatment plant is treated in a high solids digester, optionally a mechanically mixed wet digester. Sludge (i.e. digestate) from the anaerobic digester is thickened or dewatered. Part of the thickened or dewatered digestate is thermally hydrolysed. The hydrolysed digestate may be, or may be further treated to produce, Class A biosolids. The hydrolysed digestate can be dewatered producing a liquid fraction that is recycled to the digester. Another part of the thickened or dewatered digestate is returned to the digester. The return of thickened or dewatered digestate to the digester allows for a smaller tank to be used (compared to a system without a recycle of thickened or dewatered digestate) while maintaining the same solids residence time (SRT) and volatile solids reduction (VSR). In some examples, the hydraulic residence time (HRT) of the digester is 10 days or less.

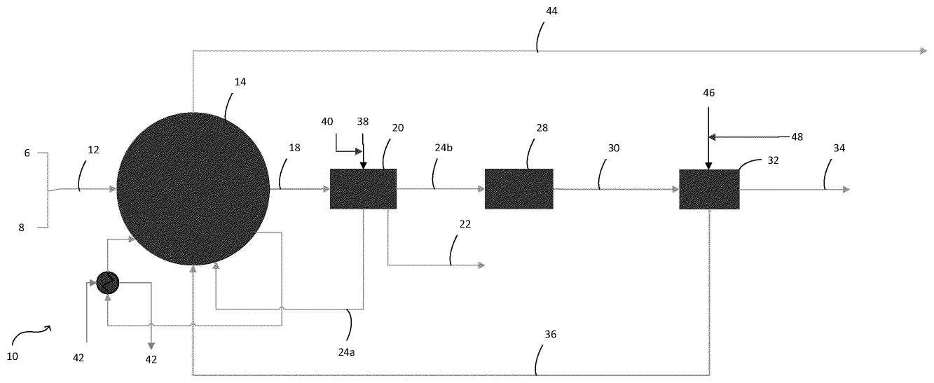

### FIELD

This specification relates to treating sewage sludge and anaerobic digestion.

### BACKGROUND

A typical wastewater treatment plant (WWTP) produces one or more sewage sludges such as primary sludge and waste activated sludge. Some or all of the sewage sludge may be thickened up to about 4 wt % dried solids before feeding a conventional digester. The sewage sludge can be further treated in a mesophilic anaerobic digester. The resulting digestate is a Class B biosolid for land application with no value or limited value.

Thermal hydrolysis is most commonly used in commercial anaerobic digesters according to the CAMBITHP process (or equivalents from other suppliers). In the typical form of this process, waste sludge is hydrolysed by a combination of heat (about 160 degrees C.) and pressure (at least several atmospheres, typically above 5 bar) prior to anaerobic digestion. Because the viscosity of the waste sludge is reduced in the process, the waste sludge may be thickened, for example to about 8-16% dried solids by weight (DS) before hydrolysis. The anaerobic digester then operates at about 4-6% DS in the digester compared to 2-3% DS for a conventional digester coupled to a WWTP.

International Publication Numbers WO 2014/137218 describes a system in which biomass is first treated in a digester and then treated by thermal hydrolysis. WO 2016/066752 describes a system in which thermal hydrolysis is provided upstream of a digestion tank and part of the content of the digestion tank is used to dilute the hydrolysis product. United States Publication Number US 2008/0050941 A1 describes a system in which sludge from a wastewater treatment plant is treated by two stages of anaerobic digestion in series separated by intermediate thickening and hydrolysis.

### INTRODUCTION TO THE INVENTION

This specification describes a system and process in which sludge from a wastewater treatment plant is treated in a high solids digester, optionally a mechanically mixed wet digester. Sludge (i.e. digestate) from the anaerobic digester is thickened or dewatered. Part of the thickened or dewatered digestate is hydrolysed to produce a hydrolysed sludge. The hydrolysed sludge may be dewatered to a high solids content, for example 33% total solids (TS) or more. In some jurisdictions, the hydrolysed sludge may be considered a Class A biosolid, or similarly designated biosolid. Optionally, the hydrolysed sludge may undergo one or more post treatment steps, for example drying, to produce Class A biosolids. Another part of the thickened or dewatered digestate is returned to the digester. The return of thickened or dewatered digestate to the digester allows for a smaller tank to be used (compared to a system without a recycle of thickened or dewatered digestate) while maintaining the same solids residence time (SRT) and volatile solids reduction (VSR) and reducing the hydraulic retention time (HRT). In some examples, the HRT of the digester is 10 days or less.

The hydrolysed digestate may be dewatered. A liquid portion produced by dewatering the hydrolysed digestate may be returned to the digester. This liquid portion contains soluble organic matter that was not digested in the first pass of the sludge through the digester. The thermal hydrolysis process releases some of the undigested organic matter in the form of soluble organic matter, which remains in the liquid fraction of dewatering. This liquid fraction with soluble organics is easy to co-digest in the digester along with raw sludge. Returning the liquid fraction produces more biogas as a result of higher volatile solids reduction.

### BRIEF DESCRIPTION OF THE FIGURES

The FIGURE shows a process flow diagram of a sludge treatment system.

### DETAILED DESCRIPTION

The FIGURE shows a sludge treatment system 10. The system 10 may be used, for example, to treat sludge 12 from a municipal wastewater treatment plant (WWTP) (not shown). The sludge 12 may include primary sludge (PS) 6, waste activated sludge (WAS) 8, or both. The sludge 12, or part of it, may have been pre-thickened in the wastewater treatment plant. For example, the waste activated sludge 8 may be pre-thickened to about 3-6% total solids (TS). The sludge 12 may have a solids content of about 3-6% TS, for example, about 4% TS.

The system 10 includes an anaerobic digester 14 with an inlet to receive the sludge 12. The digester 14 may be, generally speaking, a covered tank with mixers. In the case of an existing WWTP, there may already be one or more digester tanks, typically, operated with hydraulic and solids retention times of 15 to 20 days. One of these tanks might be suitable to be converted for use in the system 10. However, the digester tank volume required for a WWTP using a conventional sludge digestion process is much larger than what is required for the system 10. Accordingly, if there are two existing tanks, one might be used in the system 10, or the excess capacity of a single tank can be used by also importing food waste, industrial sludge, or another external waste source to the WWTP. Alternatively, a new digester may be constructed. Optionally, the digester 14 may be heated with hot water 42 flowing through a heat transfer system. The digester 14 produces biogas 44, which can be used as a fuel.

The digester 14 operates in the system 10 with a low hydraulic retention time (HRT), for example, 5-10 days, 5-7 days, 5 days, or 7 days. The solids content in the digester is higher than in a typical WWTP. For example, the digester 14 may operate at 4-8% TS, for example, about 4% TS. The solids content in the digester 14 may be too high for conventional gas, pump or draft tube mixing. The digester 14 may be mechanically mixed, for example with hydraulic or electric submersible mixers. Mechanical mixers may use a spinning blade or other moving solid object in contact with the digestate to stir or otherwise mix the digestate in the digester 14. For example, high torque, low speed submersible mixers are available from UTS Products GmbH in Lippetal, Germany or related companies UTS Biogas Ltd., Cambridgeshire, UK, and Anaergia Services in the US under the OMNIVORE trademark. These mixers use an immersed hydraulic motor driven by an external hydraulic power unit that circulates biodegradable hydraulic oil, such that if leaks occur inside the digester 14 then the bacteria can degrade the non-toxic leaked oil. Usually two or more mixers are needed per digester 14, depending on the digester tank dimensions. Alternatively, UTS electrical mixers with a permanent magnet synchronous motor may be used. These mixers are described in United States Patent Application Publication Number US 2018/0023046, Method for Operating a Stirring Device and a Fermenter, which is incorporated herein by reference. These mixers are able to mix digestate at 6-10% or more TS.

Digestate 18 is drawn from an outlet of the digester 14. Although the term digestate is sometimes used to refer specifically to the solids fraction in digested sludge, in this document “digestate” refers to the sludge removed from a digester unless indicated otherwise. The digestate 18 in the example shown is thickened in thickener 20. Thickener 20 may be, for example, a screw thickener having a tapered auger inside of a cylindrical screen. A suitable screw thickener is shown in International Publication Number WO 2013/155630 A1, Sludge Screw Thickener with Screen Rotation During Cleaning, by Anaergia Inc., which is incorporated herein by reference. This type of thickener 20 can produce a thickened digestate having 12% TS or more, optionally 15% TS or more, up to about 20%. A polymer solution 38, optionally diluted with potable water or plant service water 40, is optionally added to the thickener 20 to help process the digestate 18.

Alternatively, if the WWTP already has dewatering equipment, then a dewatering unit may be used in place of the thickener. However, in this case the dewatered digestate might require some dilution before it can be hydrolysed, as discussed further below.

The thickener 20 produces a liquid fraction 22 and a solid fraction 24. The liquid fraction 22 contains ammonia and is optionally treated to extract the ammonia, for example by passing the liquid fraction through an ammonia stripper. The extracted ammonia can be processed to produce, for example, ammonium hydroxide or ammonium sulfate, which are useful in making fertilizer. The liquid fraction 22 can optionally be treated for further nutrient recovery (for example of phosphorous). The liquid fraction 22, with or without treatment to remove ammonia or other nutrients, can be returned to the headworks of the WWTP.

Optionally, a first portion 24a of the solid fraction is recycled to the digester 14. The amount of the first portion 24a recycled to the digester 14 may be from about 10% to about 60% (v/v) of the solid fraction 24, for example, from about 15% to about 50%, or from about 16% to about 46%, such as about 16%, about 26%, about 29%, about 44%, about 46%, or from any one of the above-noted percentages to any one of another of the above-noted percentages. The first portion 24a may be extracted continuously from the thickened or dewatered fraction, or by diverting the entire solid fraction for discontinuous periods of time. Recycling the first portion 24a of the solid fraction provides recuperative thickening of the digester 14 thereby increasing the solids content in the digester 14, its solids retention time (SRT) and its organic loading rate (OLR). Although the HRT of the digester 14 may be in the range of 5-10 days, 5-7 days, 5 days, or 7 days, the SRT may be longer, for example, 15-30 days, 15-25 days, 15 days, 20, days, or 30 days. Alternatively, a thickener, preferably a high solids thickener (for example a screw thickener or belt thickener) is added upstream of the digester 14. This thickener may increase the solids content of sludge 12, for example to 12-14% TS, before sludge 12 is fed to the digester 14. However, it is preferred to use recuperative thickening since in that case the same thickener 20 can be used to provide solid fraction 24 to the digester 14 and for hydrolysis.

The solid fraction 24 may have a solids content of at least 12% TS or at least 15% TS, for example about 16%. The solids content of the solid fraction 24 may be up to the limits of the hydrolysis unit 28, which may be about 20% TS or 22% TS.

A second portion 24b of the solid fraction 24 is treated in a hydrolysis unit 28. In some examples, the hydrolysis unit 28 may be a thermal hydrolysis unit that uses heat, and optionally pressure, to treat the solid fraction 24. Commercial hydrolysis units are available, for example, from Cambi, Veolia, Lystek. In the example of a Cambi THP unit, live steam is injected into batches of sludge in a pressurized vessel reaching about 165 degrees Celsius (C) and 6.4 bar of pressure for 20-30 minutes, followed by rapid depressurization. The hydrolysis unit 28 hydrolyses or dissolves large molecules such as extra-cellular polymeric substances (EPS) remaining in the solid fraction 24, which may facilitate further composting or land application of the solid fraction 24. The hydrolysis unit 28 also destroys pathogens and other cells in the solid fraction 24. The hydrolysis unit 28 produces a hydrolysed sludge 30, which may be a Class A biosolid or may be further treated to produce a Class A biosolid.

Optionally, the hydrolysed sludge 30 can be sent to a dewatering unit 32 to produce a sludge cake 34. Dewatering unit 32 may be a centrifuge. The dewatering unit 32 can receive hydrolysed digestate at around 100 degrees C. as it is released from the rapid depressurization chamber of a hydrolysis unit 28. Sludge cake 34 can have a solids concentration of 35% TS or more, for example about 40-45% TS or about 42% TS. A high solids content may be useful to reduce the costs associated with drying the sludge cake and/or to reduce the cost of transporting the sludge cake. Filtrate 36 produced in dewatering unit 32 may be returned to digester 14. The filtrate 36 has a high concentration of soluble organics, for example over 10% soluble chemical oxygen demand (COD). Accordingly, the filtrate 36 does not dilute the digester 14, and SRT is maintained in the digester 14 by recuperative thickening, but biogas production in the digester 14 increases. A polymer solution 46, optionally diluted with potable water or plant service water 48, is optionally added to the dewatering unit 32 to help process the hydrolysed sludge 30.

### EXAMPLES

### Example 1

In an example of a system 10 as described above, the influent was a combination 12 of primary sludge 6 and thickened waste activated sludge 8 having a solids content of 4% TS, a VS/TS of 78%, and a flow rate of 1,350 m³/d (42 tonnes per day [TPD] VS). The primary sludge 6 had a solids content of 4% TS, a VS/TS of 80%, and a flow rate of 805 m³/d (26 TPD VS). The thickened activated sludge 8 had a solids content of 4% TS, a VS/TS of 75%, and a flow rate of 545 m³/d, and (16 TPD VS).

The sludge 12 was fed into digester 14. The volatile solids reduction (VSR) in the digester 14 was 60%, the digester SRT was 20 days, the HRT was 7 days, and the OLR was 4.6 kgVS/m³/d. The digester 14 had a volume of 12,000 m³, had a biogas production 44 of 1,211 Nm³/h of 60% CH₄ (33.3 TPD VS), and produced 2,222 m³/d of digestate 18 at 6% TS.

The digestate 18 was thickened in thickener 20. A polymer solution 38 was added to the thickener 20 at a dose of 4.5 kg/T-TSS (600 kg/d). The polymer solution 38 was diluted with potable water or plant service water 40 (60 m³/d primary dilution; 340 m³/d secondary dilution). The thickener 20 produces a liquid fraction 22 and a solid fraction 24. From the thickener, a first portion 24a (578 m³/d at 16% TS) was recycled to the digester 14 (26% v/v of the solid fraction 24); a second portion 24b (225 m³/d at 16% TS; 55% VS/TS [19.8 TPD VS]) was treated in the hydrolysis unit 28; and filtrate 22 (1,820 m³/d [0.4 TPD VS]) was sent to the headworks.

The hydrolysis unit 28 produced hydrolysed sludge 30 having a solids content of 14% TS and flow rate of 258 m³/d (19.8 TPD VS). Steam used for hydrolysis was 33 TPD and 1,049 kWh/h boiler gas input (Cambi THP process).

The hydrolysed sludge 30 was dewatered in dewatering unit 32 to produce 58 TPD of sludge cake 34 having a solids content of 42% TS, a VS/TS of 34% (8.3 TPD VS), and filtrate 36 having a solids content of 3.9% TS at a flow rate of 294 m³/d (11.5 TPD VS), which was returned to the digester 14. A polymer solution 46 was added to the dewatering unit 32 at a dose of 8 kg/T-TSS (288 kg/d). The polymer solution 46 was diluted with potable water or plant service water 48 (28 m³/d primary dilution; and 66 m³/d secondary dilution).

### Example 2

In another example of a system 10 as described above, the influent was a combination 12 of primary sludge 6 and thickened waste activated sludge 8 having a solids content of 4% TS and a flow rate of 1,350 m³/d. The sludge 12 was fed into digester 14. The digester SRT was 15 days, the HRT was 7 days, had a volume of 12,000 m³, and produced 1,952 m³/d of digestate at 4.50% TS.

The digestate 18 was thickened in thickener 20. The thickener 20 produces a liquid fraction 22 and a solid fraction 24. From the thickener 20, a first portion 24a (308 m³/d at 16% TS) was recycled to digester 14 (16% v/v of the solid fraction 24); a second portion 24b (225 m³/d at 16% TS) was treated in hydrolysis unit 28; and filtrate 22 (1,684 m³/d) was sent to the headworks. A polymer solution 38 was added to the thickener 20 at a dose of 396 kg/d. The polymer solution 38 was diluted with potable water 40 (264 m³/d).

### Example 3

In another example of a system 10 as described above, the influent was a combination 12 of primary sludge 6 and thickened waste activated sludge 8 having a solids content of 4% TS and a flow rate of 1,350 m³/d. The sludge 12 was fed into digester 14. The digester SRT was 30 days, the HRT was 7 days, had a volume of 12,000 m³, and produced 3,072 m³/d of digestate at 9% TS.

The digestate 18 was thickened in thickener 20. The thickener 20 produces a liquid fraction 22 and a solid fraction 24. From the thickener 20, a first portion 24a (1,428 m³/d at 16% TS) was recycled to digester 14 (46% v/v of the solid fraction 24); a second portion 24b (225 m³/d at 16% TS) was treated in hydrolysis unit 28; and filtrate 22 (2,249 m³/d) was sent to the headworks. A polymer solution 38 was added to the thickener 20 at a dose of 1,245 kg/d. The polymer solution 38 was diluted with potable water 40 (830 m³/d).

### Example 4

In another example of a system 10 as described above, the influent was a combination 12 of primary sludge 6 and thickened waste activated sludge 8 having a solids content of 4% TS, a VS/TS of 78%, and a flow rate of 1,350 m³/d (42 tonnes per day [TPD] VS). The primary sludge 6 had a solids content of 4% TS, a VS/TS of 80%, and a flow rate of 805 m³/d (26 TPD VS). The thickened activated sludge 8 had a solids content of 4% TS, a VS/TS of 75%, and a flow rate of 545 m³/d, and (16 TPD VS).

The sludge 12 was fed into digester 14. The volatile solids reduction (VSR) in the digester 14 was 60%, the digester SRT was 15 days, the HRT was 5 days, and the OLR was 6.6 kgVS/m³/d. The digester 14 had a volume of 8,300 m³, had a biogas production 44 of 1,211 Nm³/h of 60% CH₄ (33.3 TPD VS), and produced 2,330 m³/d of digestate 18 at 6.5% TS.

The digestate 18 was thickened in thickener 20. A polymer solution 38 was added to the thickener 20 at a dose of 4.5 kg/T-TSS (682 kg/d). The polymer solution 38 was diluted with potable water 40 (68 m³/d primary dilution; 385 m³/d secondary dilution). The thickener 20 produces a liquid fraction 22 and a solid fraction 24. From the thickener, a first portion 24a (686 m³/d at 16% TS) was recycled to the digester 14 (29% v/v of the solid fraction 24); a second portion 24b (225 m³/d at 16% TS; 55% VS/TS [19.8 TPD VS]) was treated in the hydrolysis unit 28; and filtrate 22 (1,874 m³/d [0.4 TPD VS]) was sent to the headworks.

The hydrolysis unit 20 produced hydrolysed sludge 30 having a solids content of 13.9% TS and flow rate of 258 m³/d (19.8 TPD VS). Steam used for hydrolysis was 33 TPD and 1,049 kWh/h boiler gas input (Cambi THP process).

The hydrolysed sludge 30 was dewatered in dewatering unit 32 to produce 58 TPD of sludge cake 34 having a solids content of 42% TS, a VS/TS of 34% (8.3 TPD VS), and filtrate 36 having a solids content of 3.9% TS at a flow rate of 294 m³/d (11.5 TPD VS), which was returned to the digester 14. A polymer solution 46 was added to the dewatering unit 32 at a dose of 8 kg/T-TSS (288 kg/d). The polymer solution 46 was diluted with potable water 48 (28 m³/d primary dilution; and 66 m³/d secondary dilution).

### Example 5

In another example of a system 10 as described above, the influent was a combination 12 of primary sludge 6 and thickened waste activated sludge 8 having a solids content of 4% TS and a flow rate of 1,350 m³/d. The sludge 12 was fed into digester 14. The digester SRT was 20 days, the HRT was 5 days, had a volume of 8,300 m³, and produced 2,959 m³/d of digestate at 8.70% TS.

The digestate 18 was thickened in thickener 20. The thickener 20 produces a liquid fraction 22 and a solid fraction 24. From the thickener 20, a first portion 24a (1,315 m³/d at 16% TS) was recycled to digester 14 (45% v/v of the solid fraction 24); a second portion 24b (225 m³/d at 16% TS) was treated in hydrolysis unit 28; and filtrate 22 (2,191 m³/d) was sent to the headworks. A polymer solution 38 was added to the thickener 20 at a dose of 1,160 kg/d. The polymer solution 38 was diluted with potable water 40 (773 m³/d).

### Example 6

In a calculated example, a system 10 as described above was compared to an alternative system with no first portion 24a of the solid fraction recycled to the digester 14. Instead, all of the solid fraction 24 was sent to the hydrolysis unit 28. In both systems, the influent was a combination of primary sludge and thickened waste activated sludge from a co-located WWTP having a solids content of 4% TS and a flow rate of 1,350 m³/d. The two examples were forced to be equal in volatile solids reduction (VSR) in the digester (60%), digester SRT (20 days), biogas production (1137 Nm³/h of 60% CH₄) solids fraction produced (79 m³/d at 16% TS), steam used for hydrolysis (14 TPD, 445 kWh/h boiler gas input, Cambi THP process), and hydrolysed sludge produced (93 m³/d at 14.1% TS). In the example of the system 10 with recuperative thickening, the digester had a tank volume of 10,000 m³, HRT of 7 days, OLR of 4.6 kgVS/m³/d, and produced 2,047 m³/d of digestate at 6% TS. In the comparative example without recuperative thickening, the digester had a tank volume of 28,810 m³, HRT of 20 days, OLR of 1.8 kgVS/m³/d, and produced 1,420 m³/d of digestate at 2.2% TS. As indicated by this example, the system 10 allows for a significant decrease in digester size.

### Example 7

In another comparative example with a conventional system (no digester pre-thickening above 6% or recuperative thickening) having hydrolysis upstream of a digester, the required digester volume was lower (6,180 m³) but the hydrolysis unit require more steam (44 TPD, 1,400 kWh/h boiler gas input) and less biogas was produced (853 Nm³/h of 60% CH₄).

### Example 8

In another comparative example with a conventional system (no digester pre-thickening above 6% or recuperative thickening) having hydrolysis between two digesters, the required digester volume was higher and the hydrolysis unit required more steam than the system 10.

### Example 9

In another comparative example with a system as described in United States Publication Number US 2008/0050941 A1, total digester tank volume was similar (about 9,000 m³) but the hydrolysis unit require more steam (20 TPD, 645 kWh/h boiler gas input) and less biogas was produced (801 Nm³/h of 60% CH₄).

### Example 10

In another comparative example, the system 10 described in Example 4 was compared to an alternative system with no first portion 24a of the solid fraction recycled to the digester 14. Instead, all of the solid fraction 24 was sent to the hydrolysis unit 28. In both systems, the influent was a combination of primary sludge and thickened waste activated sludge having a solids content of 4% TS, a VS/TS of 78%, and a flow rate of 1,350 m³/d (42 tonnes per day [TPD] VS). The two examples were forced to be equal in volatile solids reduction (VSR) in the digester (60%), digester SRT (15 days), biogas production (1,211 Nm³/h of 60% CH₄; 33.3 TPD VS) solids fraction produced (225 m³/d at 16% TS; 55% VS/TS; 19.8 TPD VS), steam used for hydrolysis (33 TPD, 1,049 kWh/h boiler gas input, Cambi THP process), hydrolysed sludge produced (258 m³/d at 13.9% TS; 19.8 TPD VS), and dewatered filtrate returned to the digester (294 m³/d at 3.9% TS). In the example of the system 10 with recuperative thickening, the digester had a tank volume of 8,300 m³, HRT of 5 days, and OLR of 6.6 kgVS/m³/d. In the comparative example without recuperative thickening, the digester had a tank volume of 24,660 m³, HRT of 15 days, and OLR of 2.2 kgVS/m³/d. As indicated by this example, the system 10 allows for a significant decrease in digester size.

U.S. Pat. No. 9,181,120 and US Publication 2012145627 and U.S. provisional application 62/265,691 filed on Dec. 10, 2015 are incorporated by reference.

Unless stated otherwise or apparent from the context, solids contents or concentrations mentioned above are total solids (TS) measurements, which would be the same as a dried solids (DS) measurement. In digestate, the DS is roughly 10% higher than total suspended solids (TSS) and the total dissolved solids (TDS) is typically 2500 to 4000 mg/L (0.25 to 0.4%). For example, a 5% DS digestate may have 46,000 mg/L of TSS and 4000 mg/L TDS. Accordingly, solids contents or concentrations, unless specified otherwise, can generally be interpreted as TSS without causing a material difference in the process.

The descriptions of processes and apparatus above are to provide at least one example of an embodiment within each claim but not to limit or define any claim. However, multiple processes and apparatus have been described above and it is possible that a particular process or apparatus described above is not within a specific claim. Process parameters are given as examples of how a plant may be operated and are not meant to limit a claim unless explicitly recited in a claim. Other processes for similar applications might operate at parameters within ranges that are 50% or 100% larger in both directions than the parameter ranges described above, or within a 50% or 100% variation from a single parameter described above. If one or more elements or steps described above are used to treat other wastes or under other conditions, then one or more process ranges described above might not be suitable and would be substituted with other appropriate parameters. Words such as “may”, “preferable” or “typical”, or variations of them in the description above, indicate that a process step or apparatus element is possible, preferable or typical, according to the word used, but still optional and not necessarily part of any claimed invention unless explicitly included in a claim.

We claim:

1. A process for treating wastewater treatment plant (WWTP) sludge comprising the steps of,
feeding the WWTP sludge to an anaerobic digester;
extracting digestate from the anaerobic digester;
thickening or dewatering the digestate from the anaerobic digester;
returning a first portion of the thickened or dewatered digestate to the anaerobic digester;
hydrolysing a second portion of the thickened or dewatered digestate.

2. The process of claim 1 comprising operating the anaerobic digester comprising at a total solids concentration of 5% or more.

3. The process of claim 1 or 2 wherein the anaerobic digester is a mechanically mixed wet digester.

4. The process of any of claims 1 to 3 further comprising dewatering the hydrolysed digestate.

5. The process of claim 4 further comprising returning a liquid fraction produced from dewatering the hydrolysed digestate to the anaerobic digester.

6. The process of any of claims 1 to 5 wherein the hydraulic residence time (HRT) of the digester is 10 days or less.

7. The process of any of claims 1 to 6 wherein the digestate is thickened or dewatered to a total solids concentration of 12% or more.

8. The process of any of claims 1 to 7 wherein the amount of the first portion is from about 10% to about 60% (v/v), or from about 15% to about 50%, of the thickened or dewatered digestate.

9. A system for treating wastewater treatment plant (WWTP) sludge comprising,
an anaerobic digester having an inlet connected the WWTP to receive sludge from the WWTP and an outlet;
a sludge thickening or dewatering unit having an inlet connected to the outlet of the anaerobic digester and an outlet;
a thermal hydrolysis unit having an inlet connected to the outlet of the sludge thickening or dewatering unit;
a recirculation pathway connecting the outlet of the sludge thickening or dewatering unit to the anaerobic digester.

10. The system of claim 9 wherein the anaerobic digester operates at a total solids concentration of 5% or more.

11. The system of claim 9 or 10 wherein the anaerobic digester is a mechanically mixed wet digester.

12. The system of any of claims 9 to 11 further comprising a dewatering unit connected to an outlet of the thermal hydrolysis unit.

13. The system of claim 12 wherein a liquid fraction outlet of the dewatering unit is connected to the anaerobic digester.

14. The system of any of claims 9 to 13 wherein the hydraulic residence time (HRT) of the digester is 10 days or less.

15. The system of any of claims 9 to 14 wherein the anaerobic digester comprises an electrically or hydraulically driven mixer.

16. The system of any of claims 9 to 15 wherein about 10% to about 60% (v/v), or from about 15% to about 50%, of the thickened or dewatered digestate from the sludge thickening or dewatering unit is returned to the anaerobic digester along the recirculation pathway.
